(19) United States
(12) Patent Application Publication
(10) Pub. No.: US 2016/0050147 A1
(43) Pub. Date: Feb. 18, 2016

(54) DISTRIBUTING ROUTE

(71) Applicant: Hangzhou H3C Technologies Co., Ltd., Hangzhou City (CN)

(72) Inventor: Haifeng ZHANG, Beijing (CN)

(21) Appl. No.: 14/827,185

(22) Filed: Aug. 14, 2015

(30) Foreign Application Priority Data
Aug. 15, 2014 (CN) 201410403857.8

(51) Int. Cl. H04L 12/741

(52) U.S. Cl. CPC H04L 45/745

(57) ABSTRACT

This disclosure proposes a method for distributing a route, the method includes: respective BGP routers report updated routes to a BGP route reflector; the BGP route reflector distributes a target route to the target BGP router configured with VRF according to the collected updated routes, where the target route carries a RT tag of the VRF and multiple next hops, and different NT tags are allocated in advance for the respective next hops in the target route; and the target BGP router receives the target route reflected by the BGP route reflector, adds the target route to a corresponding VRF routing table according to the RT tags, and forwards a received message to the next hop of which the NT tag matches with one of the RT tags of VRF of the message, when the received message matches with the target route.

### FIELD

### Background

Border Gateway Protocol (BGP) is applicable to both a dynamic route protocol among multiple Autonomous Systems (ASs) and a dynamic route protocol within single AS. The BGP operating within single AS can be referred to Internal Border Gateway Protocol (IBGP); and the BGP operating among multiple ASs can be referred to as External Border Gateway Protocol (EBGP). AS may include a set of routers possessing the same route selection policy and belonging to the same technical administration department. Moreover, Route Reflector (RR) mechanism is introduced to the BGP, so that all of network devices within AS may be connected with the RR only using the IBGP.

### BRIEF DESCRIPTION OF THE DRAWINGS

FIG. 1 is a flowchart illustrating a method for distributing route, in accordance with examples of the present disclosure;

FIG. 2 illustrates a network deployment diagram of traffic of a target BGP router being controlled and scheduled by a BGP route reflector in a centralized manner, in accordance with examples of the present disclosure;

FIG. 3 illustrates a block diagram of a device for distributing a route in accordance with examples of the present disclosure;

FIG. 4 illustrates a hardware structural diagram of a BGP route reflector including the device for distributing a route in accordance with examples of the present disclosure;

FIG. 5 illustrates a block diagram of another device for distributing a route in accordance with examples of the present disclosure; and

FIG. 6 illustrates a hardware structural diagram of a BGP router including the other device for distributing a route in accordance with examples of the present disclosure.

### DETAILED DESCRIPTION

When a RR route reflector (simply RR router hereafter) performs centralized controlling and scheduling on traffic within an AS, typically multiple topologies are configured on a target BGP router within the AS, and multiple IBGP connections can be established between the target BGP router and the RR router so that the RR router distributes routes for the respective topologies after establishing a neighbor relationship with the target BGP router over the multiple IBGP connections.

However in the solution above, since there are the multiple IBGP connections between the target BGP router and the RR router, the RR router needs to establish the neighbor relationship with the target BGP router for multiple times, that is, there is a multi-neighbor relationship between the RR router and the target BGP router. Moreover, when the RR router distributes the routes for the respective topologies of the target BGP router and specifies next hops, only one next hop can be specified for each of the routes, so the RR router needs to distribute one copy for each of the topologies of the target BGP router, thus the performance of the network is greatly degraded.

In view of this, this disclosure proposes a method for distributing a route, where the RR router distributes a route for another BGP router by carrying Route Target (RT) tags in the route for distinguishing Virtual Routing and Forwarding (VRF), adding multiple next hops added to the route, and allocating different Next hop Target (NT) tags for the respective next hops, and where a receiver forwards a message by comparing the RT tags of the VRF with the NT tags to determine the next hop to which the message is forwarded, to thereby select flexibly the next hop for each of the topologies so as to perform centralized controlling and scheduling on the traffic.

Since the multiple next hops can be specified for each of the routes in this solution, the RR router can distribute the route for the target BGP router without distributing one copy for each of the topologies, and the multi-neighbor relationship will not be maintained between the RR router and the target BGP router, but a route in a BGP public network can be distributed per topology using a single-neighbor relationship.

This disclosure will be detailed below in details by way of an example with reference to the drawings.

Referring to FIG. 1, this disclosure proposes a method for distributing a route, applicable respectively to a BGP route reflector and a BGP router, which cooperate with each other to perform the following blocks:

Block 101, the respective BGP router reports an updated route to the BGP route reflector.

In this example, when the respective BGP router in a network learns a new route, the BGP router reports the learned route to the RR router as the updated route, and the RR router further distributes the updated route to a target BGP router correspondingly, where the updated route can be a route in a public network or a route in a private network; and the target router can be determined by a particular service, for example, in a particular implementation, the target BGP router can a BGP router in opposite end which needs to communicate with the BGP router reporting the updated route.

Block 102, the BGP route reflector distributes a target route to the target BGP router configured with VRF according to the collected updated route, where the target route carries Route Target (RT) tags of the VRF and multiple next hops, and different NT tags are allocated in advance for the respective next hops in the target route.

In this example, the target BGP router can be configured locally with one or more VRF, where the number of locally configured VRF is determined particularly by a real service. For example, the target BGP router configured locally with multiple topologies can bind one VRF respectively to each of the topologies. Of course, the target BGP router configured locally with multiple topologies can alternatively allocate one same VRF for all the topologies. That is, in a particular implementation, the BGP router is configured locally with the multiple topologies, the number of which can be in one-to-one correspondence to the number of VRF or can be in multiple-to-one correspondence to the number of VRF, where each of the VRF can be regarded as a standalone virtual router to distinguish different forwarding instances from each other. For example, multiple virtual routers, i.e., multiple VRF, can be assigned on a physical router, where each of the VRF corresponds to a forwarding instance and is provided with its separate routing table, forwarding table and corresponding interface, so that traffic between the different VRF can be isolated from each other.

In this example, when the target BGP router is involved in forwarding a message in a private network, it needs to be configured locally with the VRF by further configuring the different local VRF with Route Distinguisher (RF) tags, where the RD tags distinguish the different VPN instances from each other to multiplex an IP address (an IP address in the private network) among the VPN instances; and the RT tags distinguish the respective VRF so that a routing table entry can be added to the route forwarding table of the respective VRF by matching the RT tag.

In this example, the RR router can obtain a global topology of the current network by exchanging messages with the other BGP routers in the network before distributing the target route to the target BGP router configured with the VRF. For example, the Intermediate System to Intermediate System (IS-IS) protocol can operate on the respective BGP routers (including the RR router) in the network so that the respective BGP router exchange IS-IS messages with each other to announce link states, and the respective BGP routers calculate the network topology separately by collecting the link states of the other respective BGP routers in the network, where the IS-IS protocol operates on the respective BGP routers so that the BGP routers announce the link states and calculate the topology in a particular implementation which can be referred to the prior art, so a repeated description thereof will be omitted here.

The RR router issues the corresponding target route for the target BGP router referring to the updated routes reported by the respective BGP routers after obtaining the global topology of the network.

Particularly the RR router can obtain on its own initiative the RT tags of the VRF with which the respective BGP routers are configured locally, from the respective BGP routers, and then distribute the corresponding target route to the target BGP router, and specify different next hops for different VRF, according to the obtained RT tags under a preset distribution policy. For example, in a particular implementation, the IS-IS protocol still can operate on the respective BGP routers so that the respective BGP routers can carry the RT tags of the locally configured VRF in the IS-IS messages and announce them to the RR router; or the updated routes reported by the respective BGP routers to the RR router can carry the RT tags directly.

Of course, in a particular implementation, the RT tags of the VRF with which the respective BGP routers in the network are configured locally can also be preconfigured on the RR router, for example, a correspondence relationship between the local VRF of the respective BGP routers and the RT tags can be preconfigured by an administrator on the RR router so that the RR router will distribute the route to the target BGP router in the network directly according to the locally preconfigured correspondence relationship between the VRF and the RT tags under the preset distribution policy without obtaining the RT tags of the local VRF from the respective BGP routers.

In this example, the preset distribution policy is determined particularly by a real service demand, for example, in a particular application, there is typically such a demand that different service traffic being carried into different VRF, so the preset distribution policy can be such that the BGP route reflector distributes the target route to the target BGP router configured with multiple VRF by specifying different next hops respectively for one same target route in the different VRF.

It shall be noted that in this example, each of the next hops may carry one or more different NT tags, so that respective messages forwarded in different VRF can be carried onto one same next hop, where one same next hops carries multiple NT tags.

Moreover in a particular implementation, the preset distribution policy can be configured locally on the RR router or can be configured on a policy server or a network administration center connected with the RR router. For example, in real network deployment, the RR router is typically connected with the policy server and the network administration center, so in an implementation, the correspondence relationship between the VRF and the RT can be maintained in advance on the RR (configured manually by the administrator or obtained by the RR router on its own initiative from the other BGP router), and the RR router can reflect the route by adding the RT tag of the corresponding VRF to the route automatically as required by the policy server or the network administration center, so as to distribute the target route for the target BGP router.

Block 103, the target BGP router receives the target route distributed by the BGP route reflector, where the target route carries the RT tags of the local VRF and the multiple next hops, and the different NT tags are allocated in advance for the respective next hops in the target route, the target route is added to the corresponding VRF routing table according to the RT tags, and a received message is forwarded to the next hop, whose NT tag matches with a RT tag of VRF of the message when the message matches with the target route.

In this example, upon receiving the target route distributed by the RR router, the target BGP router firstly matches the RT tags carried in the target route sequentially with the RT tags of the locally configured one or more VRF, and then adds the target route to the route forwarding table of the VRF matching with the RT tag carried in the target route. For example, if the RT tags carried in the target route are 1:1 and 1:2, and the target BGP router is configured locally with VRF-VOICE and VRF-DATA, whose two RT tags are 1:1 and 1:2, then since the RT tags carried in the target route match respectively with the RT tags of VRF-VOICE and VRF-DATA, the target route needs to be added respectively to the VRF route forwarding tables corresponding to VRF-VOICE and VRF-DATA.

When the target BGP router processes the message, if the message matches with the target route, then the target BGP router further determines the next hops to which the message is forwarded, according to the NT tags in the matching route. Specifically, target BGP router compares the NT tags of the next hops carried in the target route sequentially with the RT tags of the VRF of the message, and if the NT tag of any one of the next hops carried in the target route is the same as the RT tag of the VRF of the message, then the target BGP router forwards the message to that next hop. For example, if the target BGP router is configured locally with two VRF, i.e., VRF-VOICE and VRF-DATA respectively, and the RT tags are 1:1 and 1:2 respectively, then VRF-VOICE is allocated for the message as VRF; and there are two next hop devices of the target BGP router, i.e., CR-E and CR-F respectively; and if NT tags specified in the target route for the two next hops of CR-E and CR-F of the target BGP router are 1:1 and 2:2 respectively, then since the NT tag of CR-E is the same as the RT tag of VRF-VOICE, the message carried in VRF-VOICE will be forwarded onto the next hop CR-E.

In this example, the target BGP router can allocate the VRF for the received message under a preset allocation policy. For example, in a preferred embodiment, the preset allocation policy can be such that the VRF can be allocated according to the source of the message so that different forwarding topologies can be allocated respectively for messages from different message sources. Of course, in a particular implementation, the VRF can be allocated for the received message also referring to other factors, e.g., the type of the message, the type of service corresponding to the message, etc., which will not be particularly limited in this example but can be selected flexibly in a particular implementation dependent upon the real service demand.

As can be apparent from the description above, since multiple next hops can be specified in the target route, and different NT tags can be allocated in advance for the multiple next hops, the target BGP router can process the message by matching the RT tags of the VRF of the message with the NT tags to determine the next hop to which the message is forwarded, and forwarding the message to the next hop with the NT tag matching with the RT tag of the VRF of the message.

As can be apparent, in this example, the RR router will not create any multi-neighbor relationship with the target BGP router, distribute the route and specify the next hops for the target BGP router respectively in the locally configured different VRF, instead can maintain a single-neighbor relationship with the target BGP router and specify the different next hops for the target BGP router respectively in the different locally configured VRF simply using a single route, so the target route can be distributed more centrally to thereby perform centralized controlling and scheduling of traffic so as to provide the SDN solution with good means of centralized route control.

This disclosure will be described below in details by way of a particular example and in connection with a network deployment environment.

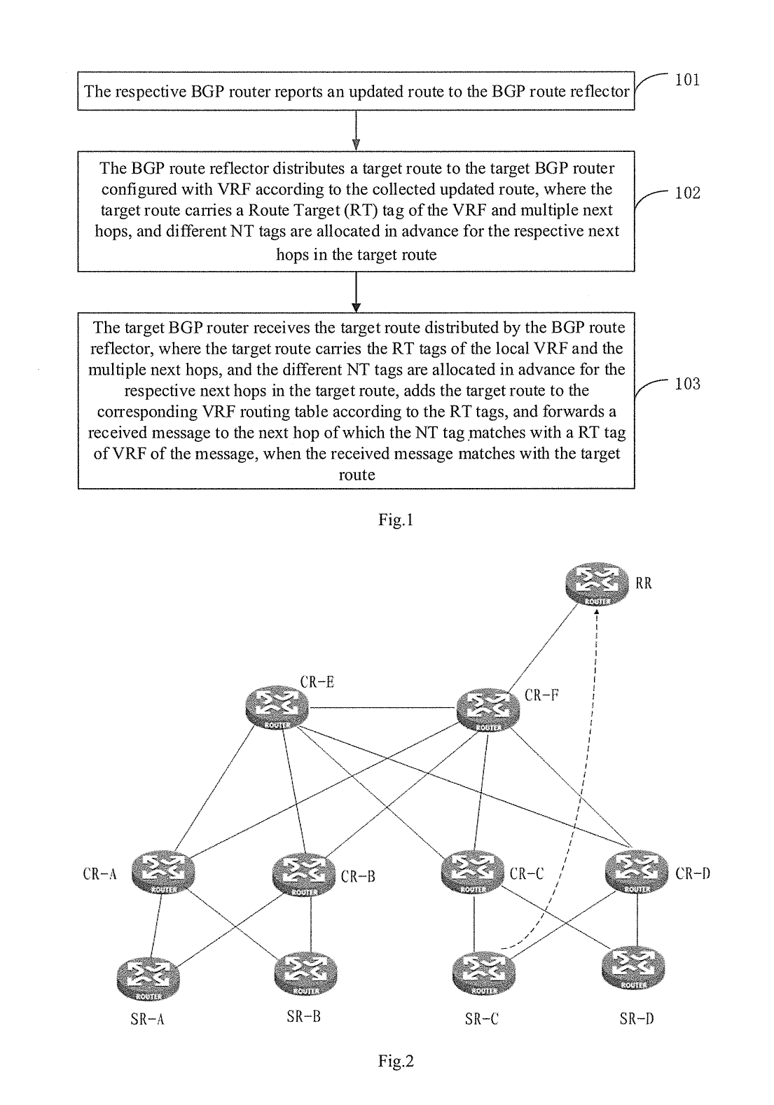

For example, referring to FIG. 2, if the RR router needs to perform centralized controlling and scheduling on traffic of the CR-A in the AS so that the traffic of SR-A and SR-B to SR-C needs to be forwarded respectively along SR-A→CR-A→CR-E→CR-C→SR-C and SR-B→CR-A→CR-F→CR-C→SR-C, where the IP address of SR-C is 10.1.1.0/224.

In this example, the BGP router further includes a Core Router (CR) and a Service Router (SR), where the CR router generally controls and schedules traffic in the network, so in this example, multiple VRF is configured on the CR router to control and schedule traffic in the network, and the SR router acts as an access router to provide a user with an access service. An example in which multiple VRF is configured on the CR router to control and schedule traffic in the network will be described below in details.

A particular implementation is as follows:

1) Preparation

Two VRF are configured on the CR-A for services, i.e., VRF-VOICE and VRF-DATA respectively, and different RTs and RDs are configured respectively for VRF-VOICE and VRF-DATA. For example, the RDs of VRF-VOICE and VRF-DATA can be configured respectively as 10:10 and 20:20; and the RTs of the VRF-VOICE and VRF-DATA can be configured respectively as 1:1 and 2:2.

The CR-A can allocate different VRF for SR-A and SR-B. For example, CR-A can allocate VRF-VOICE and VRF-DATA respectively for SR-A and SR-B dependent upon different message sources so that the CR-A forwards the received traffic of SR-A in VRF-VOICE, and the received traffic of SR-B in VRF-DATA. Of course, in a real application, SR-A can alternatively configure VRF-VOICE and VRF-DATA respectively on SR-A and SR-B so that the CR-A forwards the received traffic of SR-A in VRF-VOICE, and the received traffic of SR-B in VRF-DATA.

2) Target Route Distribution

The RR router collects updated routes reported by the respective BGP routers in the network, and then distributes a target route to CR-A under the preset distribution policy. The RR router can distribute the target route to CR-A by creating a BGP neighbor relationship with CR-A, and then interacting a BGP Update message based upon the created neighbor relationship.

Here the RR router will create the BGP neighbor relationship with CR-A, and distribute the target route to CR-A in this example differently from in the prior art. The differences of this example from the prior art will be described below in details in connection with a network deployment environment.

A particular implementation in the prior art is as follows:

Further referring to FIG. 2, there are two links that connect the RR router with the CR-A, respectively along CR-A→CR-E→CR-F→RR and CR-A→CR-F→RR. The RR router creates neighbor relationships respectively with the CR-A based upon these two links, that is, a multi-neighbor relationship is maintained between the RR router and CR-A so that each of the links corresponds to a BGP session, and the RR router distributes the route 10.1.1.0/224 of SR-C respectively to VRF-VOICE and VRF-DATA with which the CR-A is configured locally in BGP Update messages based upon the two different BGP sessions and specifies next hops respectively for VRF-VOICE and VRF-DATA; and since only one next hop can be specified for a route, two routes need to be distributed respectively as follows:

| Target IP | Next hop |
|---|---|
| 10.1.1.0/224 | CR-E |

| Target IP | Next hop |
|---|---|
| 10.1.1.0/224 | CR-F |

Upon reception of the two routes above, CR-A will forward messages of the different topologies to the different next hops specified respectively in the routes.

A particular implementation of this disclosure is as follows:

In this example, a single-neighbor relationship is maintained between the RR router and CR-A, where the RR router can create the neighbor relationship with CR-A by selecting either CR-A→CR-E→CR-F→RR or CR-A→CR-F→RR. For example, in a particular implementation, the RR router can create the neighbor relationship with CR-A by selecting the link with the smaller number of hops. After the neighbor relationship is created, the RR router distributes the route 10.1.1.0/224 of SR-C CR-A by sending a BGP Update message, and specifies a next hop; and since one next hop can be specified for a route in this solution, only one route needs to be distributed as follows:

| Target IP | RT tag | Next hop | NT tag |
|---|---|---|---|
| 10.1.1.0/224 | 1:1/2:2 | CR-E | 1:1 |
| | | CR-F | 2:2 |

It shall be noted that since 10.1.1.0/224 is a route in the public network, the RR router can distribute the route which does not carry any RD tag.

After CR-A receives the route, since the route carries both the RT tags of VRF-VOICE and VRF-DATA, CR-A adds the route respectively to the VRF route forwarding tables corresponding to VRF-VOICE and VRF-DATA. Also since the NT tag of the next hop CR-E matches with the RT tag of VRF-VOICE, the message carried in VRF-VOICE will be forwarded onto the next hop CR-E, and since the VRF allocated for the message of SR-A is VRF-VOICE, the message of SR-A will be forwarded finally onto the target device SR-C through the next hop CR-E; and alike the message carried in the VRF-DATA will be forwarded onto the next hop CR-F, and since the VRF allocated for the message of SR-B is VRF-VOICE, the message of SR-B will be forwarded finally onto the target device SR-C through the next hop CR-F.

Here the RR reflects the target routes to SR-A and SR-B in such a way that in order to forward traffic of SR-A and SR-B along SR-A→CR-A→CR-E→CR-C→SR-C and SR-B→CR-A→CR-F→CR-C→SR-C, the RR router can reflect the target routes to SR-A and SR-B by setting both the next hops in the target routes reflected for SR-A and SR-B to CR-A, instead of carrying the multiple next hops, to thereby forward both the traffic of SR-A and SR-B to the next hop CR-A.

It shall be noted that the traffic is controlled and scheduled in the CR router, but in a particular implementation, the traffic can be controlled and scheduled on the SR router.

For example, multiple VRF can be configured respectively on SR-A and SR-B, and SR-A and SR-B can allocate different VRF for different locally accessing hosts dependent upon different message sources. The RR router can reflect target routes to SR-A and SR-B by carrying multiple next hops to thereby control traffic of different hosts to be forwarded through different VRF, and reference can be made to the foregoing example for a particular implementation thereof, so a repeated description thereof will be omitted here.

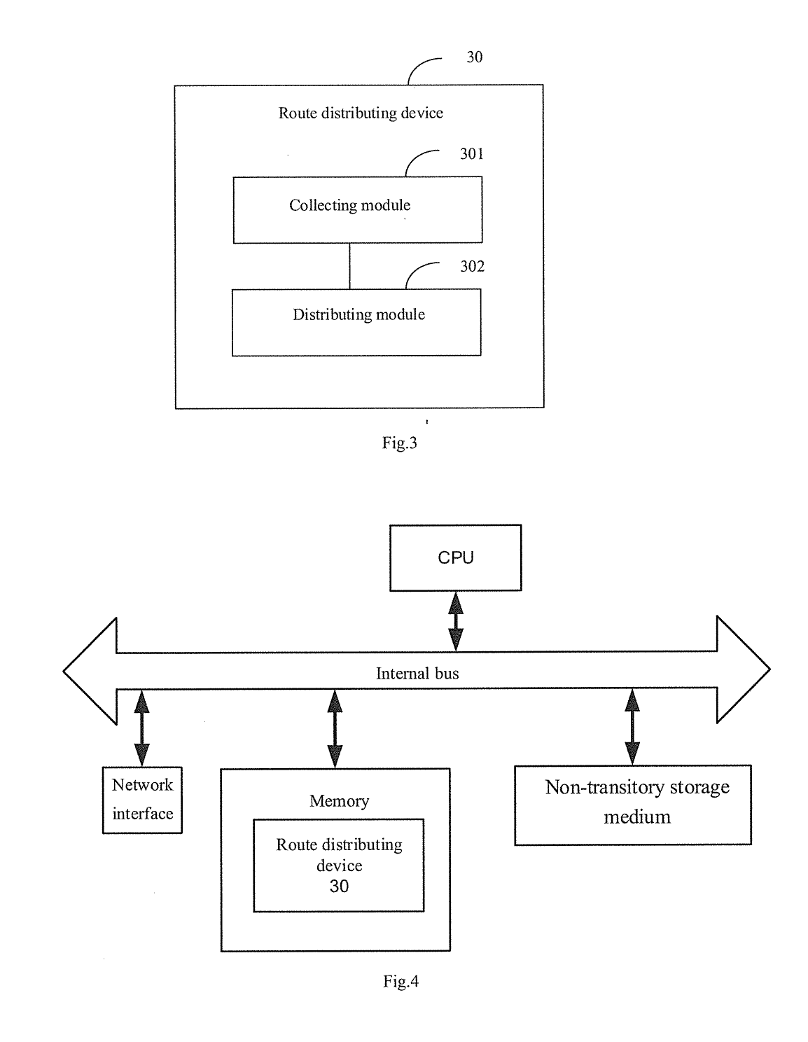

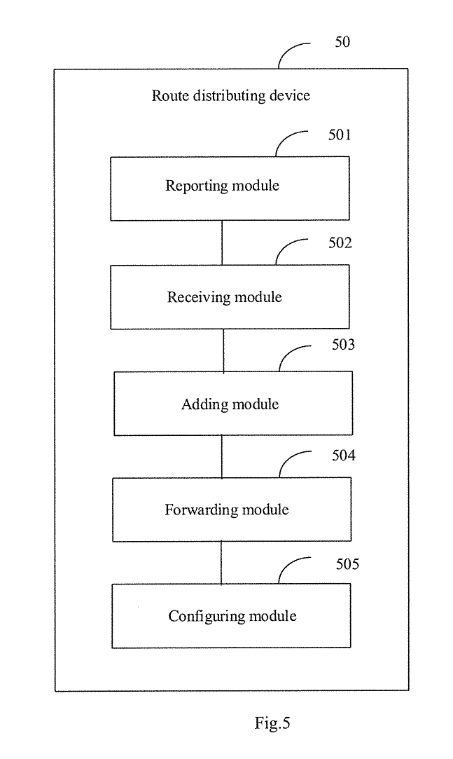

Referring to FIG. 3, this disclosure proposes a device 30 for distributing a route, applicable to a BGP route reflector, where referring to FIG. 4, a hardware architecture of the BGP route reflector including the device 30 for distributing a route typically includes a CPU, a memory, a non-transitory storage medium, a network interface, an internal bus, etc.

The non-transitory storage medium may store machine readable instructions, which are used for implementing the method for distributing route. Operations completed by running the machine readable instructions, which are read by the CPU into the memory, are functions of the device for distributing route in the memory.

The CPU may load the machine readable instructions of the non-transitory storage medium into the memory to be run, so as to form computer executable instructions. The computer executable instructions may be stored in a collecting module 301, a distributing module 302 in the BGP route reflector.

If the device 30 of this disclosure is embodied in software, then the device 30 can typically be regarded as computer program loaded in the memory and executed by the CPU resulting in a logic device embodied in both software and hardware; and the device 30 includes:

A collecting module 301, that is configured to collect updated routes reported by respective BGP routers; and

A distributing module 302, that is configured to distribute a target route to a target BGP router configured with VRF according to the collected updated routes, where the target route carries Route Target (RT) tags of the VRF, and multiple next hops, and different Next hop Target (NT) tags are allocated in advance for the respective next hops in the target route.

In this example, the distributing module 302 is further configured:

To obtain RT tags of local VRF of the respective BGP routers; and

To distribute the target route carrying the RT tags and the multiple next hops to the target BGP router according to the obtained RT tags under a preset distribution policy.

In this example, the distributing module 302 is further configured:

To preconfigure locally a correspondence relationship between local VRF of the respective BGP routers and RT tags; and

To distribute the target route carrying the RT tags of the VRF and the multiple next hops to the target BGP router according to the locally preconfigured correspondence relationship under a preset distribution policy.

In this example, each of the next hops carries multiple different NT tags.

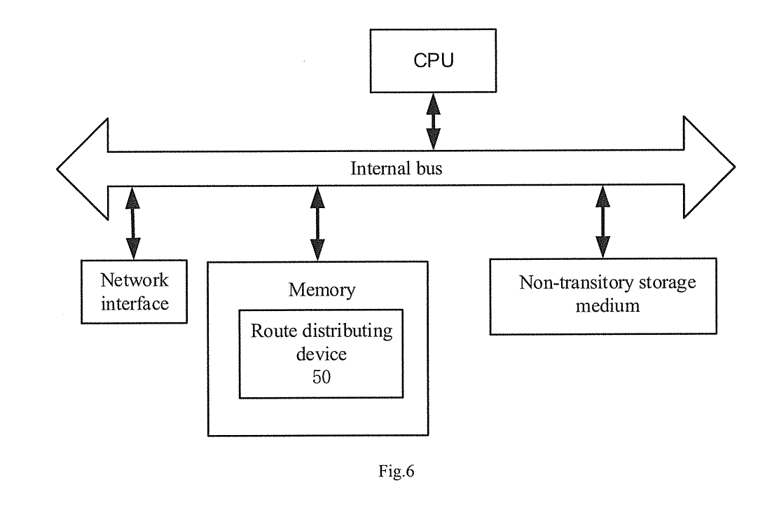

Referring to FIG. 5, this disclosure proposes a device 50 for distributing a route, applicable to a BGP router, where referring to FIG. 6, a hardware architecture of the BGP router including the device 50 for distributing a route typically includes a CPU, a memory, a non-transitory storage medium, a network interface, an internal bus, etc.

The non-transitory storage medium may store machine readable instructions, which are used for implementing the method for distributing route. Operations completed by running the machine readable instructions, which are read by the CPU into the memory, are functions of the device for distributing route in the memory.

The CPU may load the machine readable instructions of the non-transitory storage medium into the memory to be run, so as to form computer executable instructions. The computer executable instructions may be stored in a reporting module 501, a receiving module 502, an adding module 503, a forwarding module 504, a configuring module 505 in the BGP router.

If the device 50 of this disclosure is embodied in software, then the device 50 can typically be regarded as computer program loaded in the memory and executed by the CPU resulting in a logic device embodied in both software and hardware; and the device 50 includes:

A reporting module 501, that is configured to report an updated route to a BGP route reflector;

A receiving module 502, that is configured to receive a target route distributed by the BGP route reflector, where the target route carries RT tags of local VRF, and multiple next hops, and different NT tags are allocated in advance for the respective next hops in the target route;

An adding module 503, that is configured to add the target route to a corresponding VRF routing table according to the RT tags; and

A forwarding module 504, that is configured to forward a received message to the next hop whose NT tag matches with one of a RT tag of VRF of the message, when the received message matches with the target route.

In this example, the device further includes:

A configuring module 505, that is configured to configure multiple VRF locally and to allocate different RT tags for the multiple VRF; and

The adding module 503, that is further configured:

To match the RT tags carried in the target route sequentially with the RT tags of the multiple local VRF; and

To add the target route to the route forwarding table of the local VRF matching with one of the RT tags carried in the target route.

In this example, the forwarding module is further configured:

To allocate different VRF for messages from different message sources under a preset allocation policy.

Those skilled in the art can appreciate that the modules in the devices in the examples above can be distributed in the devices in the examples as described in the examples, or can be located in one or more devices different from the examples while being modified correspondingly. The modules in the examples above can be combined into a module or can be further divided into multiple sub-modules. The examples disclosed above have been numbered for the sake of a convenient description but are not intended to suggest superiority of one example to another.

The foregoing disclosure is merely illustrative of the preferred embodiments of this disclosure but not o intended to limit this disclosure, and any modifications, equivalent substitutions, adaptations, thereof made without departing from the spirit and scope of the disclosure shall be encompassed in the claimed scope of the this disclosure.

1. A method for distributing a route, applied to a Border Gateway Protocol (BGP) route reflector, wherein the method comprises:
collecting updated routes reported by respective BGP routers; and
distributing a target route to a target BGP router configured with Virtual Routing and Forwarding (VRF) according to the collected updated routes, wherein the target route carries a Route Target (RT) tag of the VRF and multiple next hops, and different Next hop Target (NT) tags are allocated in advance for the respective next hops in the target route.

2. The method according to claim 1, wherein said distributing the target route to the target BGP router configured with VRF comprises:
obtaining RT tags of local VRF of the respective BGP routers; and
distributing the target route carrying the RT tags and the multiple next hops to the target BGP router according to the obtained RT tags under a preset distribution policy.

3. The method according to claim 1, wherein said distributing the target route to the target BGP router configured with VRF comprises:
preconfiguring locally a correspondence relationship between local VRF of the respective BGP routers and RT tags; and
distributing the target route carrying the RT tags of the VRF and the multiple next hops to the target BGP router according to the locally preconfigured correspondence relationship under a preset distribution policy.

4. The method according to claim 1, wherein each of the next hops carries multiple different NT tags.

5. A method for distributing a route, applied to a BGP router, wherein the method comprises:
reporting an updated route to a BGP route reflector;
receiving a target route distributed by the BGP route reflector, wherein the target route carries RT tags of local VRF and multiple next hops, and different NT tags are allocated in advance for the respective next hops in the target route;
adding the target route to a corresponding VRF routing table according to the RT tags; and
forwarding a received message to the next hop of which the NT tag matches with one of the RT tags of VRF of the message, when the received message matches with the target route.

6. The method according to claim 5, further comprises:
configuring multiple local VRF, and
allocating different RT tags for the multiple local VRF; and
receiving the target route distributed by the BGP route reflector, which carries the RT tags of the local VRF and the multiple next hops comprises:
matching the RT tags carried in the target route sequentially with the RT tags of the multiple local VRF; and
adding the target route to the route forwarding table of the local VRF matching with one of the RT tags carried in the target route.

7. The method according to claim 6, further comprises:
allocating different VRF for messages from different message sources under a preset allocation policy.

8. A device for distributing a route, applied to a BGP route reflector, wherein the device comprises:
a collecting module to collect updated routes reported by respective BGP router; and
a distributing module to distribute a target route to a target BGP router configured with VRF according to the collected updated routes, wherein the target route carries Route Target (RT) tags of the VRF and multiple next hops, and different Next hop Target (NT) tags are allocated in advance for the respective next hops in the target route.

9. The device according to claim 8, wherein the distributing module is to:
obtain RT tags of local VRF of the respective BGP routers; and
distribute the target route carrying the RT tags and the multiple next hops to the target BGP router according to the obtained RT tags under a preset distribution policy.

10. The device according to claim 8, wherein the distributing module is to:
preconfigure locally a correspondence relationship between local VRF of the respective BGP routers and RT tags; and
distribute the target route carrying the RT tags of the VRF and the multiple next hops to the target BGP router according to the locally preconfigured correspondence relationship under a preset distribution policy.

11. The device according to claim 8, wherein each of the next hops carries multiple different NT tags.

12. A device for distributing a route, applied to a BGP router, wherein the device comprises:
a reporting module to report an updated route to a BGP route reflector;
a receiving module to receive a target route distributed by the BGP route reflector, wherein the target route carries RT tags of local VRF and multiple next hops, and different NT tags are allocated in advance for the respective next hops in the target route;
an adding module to add the target route to a corresponding VRF routing table according to the RT tags; and
a forwarding module to forward the message to the next hop, whose NT tag matches with one of the RT tags of the VRF of the message, when the received message matches with the target route.

13. The device according to claim 12, further comprises:
a configuring module to configure multiple local VRF and to allocate different RT tags for the multiple local VRF; and
the adding module is further to:
match the RT tags carried in the target route sequentially with the RT tags of the multiple local VRF; and
add the target route to the route forwarding table of the local VRF matching with one of the RT tags carried in the target route.

14. The device according to claim 12, wherein the forwarding module is to:
allocate different VRF for messages from different message sources under a preset allocation policy.
